(19) United States
(12) Patent Application Publication
(10) Pub. No.: US 2006/0166094 A1
(43) Pub. Date: Jul. 27, 2006

(54) Electrode and electrochemical device using the same

(75) Inventor: Tadashi Suzuki, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/322,228

(22) Filed: Jan. 3, 2006

(30) Foreign Application Priority Data
Jan. 24, 2005 (JP) 2005-015541

(51) Int. Cl. H01M 4/62; H01M 4/58; H01G 9/155

(52) U.S. Cl. 429/217; 429/231.7; 361/502

(57) ABSTRACT

An electrode and an electrochemical device using the same are provided in which excellent effects can be obtained that the filling density of the active material can be increased and the energy density can be improved. The electrode includes at least an active material, a conductive auxiliary agent, and a fluorine containing binder for binding the active material to the conductive auxiliary agent. In this electrode, a fluorine ratio Y and a filling content X of the active material in the electrode (90 wt. %≦X≦97.5 wt. %) satisfy the relationship of Y≧0.046 X−3.905. The fluorine ratio Y is a ratio of a fluorine content B on a minimum strength surface inside the electrode to a fluorine content A on the surface of the electrode (Y=B/A).

### BACKGROUND OF THE INVENTION

1. Field of the Invention

The present invention relates to an electrode usable in an electrochemical device typified by a battery, a capacitor, or the like, and to an electrochemical device using the same.

2. Description of the Related Art

Conventionally, in an electrochemical device typified by a battery, a capacitor, or the like, the required energy density has increased as the output power of an application device such as a cellular phone has increased.

Generally, an electrode employed in such an electrochemical device comprises an active material, a conductive auxiliary agent, and a binder for binding the active material to the conductive auxiliary agent. In addition, various electrodes have been proposed in which the filling density of the active material is increased in order to improve the energy density (see, for example, Japanese Patent Laid-Open Publication No. 2003-68292).

In order to increase the filling density of the active material in such a conventional electrode, the content of the conductive auxiliary agent or the binder must be lowered. However, if the content thereof is simply lowered, the conductive auxiliary agent or the binder is separated from the active material to cause the conductive auxiliary agent or the binder to distribute non-uniformly. Therefore, problems arise such as a decrease in the strength and the conductivity of the electrode.

On the other hand, if the content of the conductive auxiliary agent or the binder is increased, the content of the active material decreases along with the increase in the content thereof. Therefore, problems arise such as a decrease in the energy density.

### SUMMARY OF THE INVENTION

In view of the foregoing problems, various exemplary embodiments of this invention provide an electrode having a high filling density of an active material and capable of improving its energy density. Various exemplary embodiments of the invention also provide an electrochemical device having a high energy density using the electrode.

The present inventor has conducted extensive studies and has found that the strength of the electrode can be enhanced by forming the electrode from a coating material having a high viscosity to uniformly distribute a binder in the electrode. Therefore, the filling density of the active material in the electrode can be increased, and the energy density can be improved.

In summary, the above-described objectives are achieved by the following aspects of embodiments.

(1) An electrode comprising at least an active material, a conductive auxiliary agent, and a fluorine containing binder for binding the active material to the conductive auxiliary agent, wherein a fluorine ratio Y and a filling content X of the active material in the electrode (90 wt. %≦X≦97.5 wt. %) satisfy a relationship of Y≧0.046 X−3.905, the fluorine ratio Y being a ratio of a fluorine content B on a minimum strength surface inside the electrode to a fluorine content A on the surface of the electrode (Y=B/A).

(2) The electrode according to (1), wherein the active material is composed of a carbon material having a specific surface area of 800 to 2500 m²/g as determined by means of a specific surface area measuring method.

(3) An electrochemical device comprising the electrode according to (1) or (2).

(4) An electric double layer capacitor comprising the electrode according to (1) or (2).

In the electrode and the electrochemical device according to the present invention, excellent effects can be obtained that the filling density of the active material can be increased and the energy density can be improved.

### BRIEF DESCRIPTION OF THE DRAWINGS

FIG. 1 is a graph showing the relationship between the activated carbon content X and the fluorine ratio Y in the electrode according to Example 1 of the present invention; and

FIG. 2 is a graph showing the relationship between the specific surface area of the active material and the electrostatic capacitance thereof as well as the relationship between the specific surface area of the active material and the volumetric capacitance of the electrode.

### DETAILED DESCRIPTION OF THE PREFERRED EMBODIMENTS

The electrode according to the present invention includes at least an active material, a conductive auxiliary agent, and a fluorine containing binder for binding the active material to the conductive auxiliary agent. In this electrode, a fluorine ratio Y and a filling content X of the active material in the electrode (90 wt. %≦X≦97.5 wt. %) satisfy the relationship of Y≧0.046 X−3.905. The fluorine ratio Y is the ratio of the fluorine content B on a minimum strength surface inside the electrode to the fluorine content A on the surface of the electrode (Y=B/A).

In the electrode according to the present invention, the strength of the electrode can be improved by uniformly distributing the binder in the electrode. Therefore, the filling density of the active material can be increased, and the energy density can be improved.

In the present invention, examples of the “active material” which can be employed include: carbon materials such as mesocarbon microbeads (MCMB), natural or artificial graphite, resin fired carbon materials, carbon black, carbon fibers, and polyacene; and metal hydroxides such as nickel hydroxide and lithium cobaltate. A suitable active material is a carbon material having a specific surface area of 800 to 2500 m²/g determined by a BET method (the reason will be described later). Examples of the “conductive auxiliary agent” which can be employed in the present invention include graphite, carbon black, carbon fibers, and metals such as nickel, aluminum, copper, and silver. Further, examples of the “fluorine containing binder” which can be employed in the present invention include fluororesins and fluororubbers.

In the present invention, the term “minimum strength surface inside the electrode” refers to a surface containing the lowest strength portion in the electrode. The minimum strength surface corresponds to, for example, a stripped surface (a fracture surface) which is generated when a part of the electrode is forced to be stripped off.

If such an electrode is applied to an electrochemical device typified by a battery, a capacitor, or the like, an electrochemical device having a high energy density can be provided. For example, in an electric double layer capacitor, polarized electrodes forming a pair are opposed to each other with a separator interposed therebetween, and an insulative gasket is disposed around the polarized electrodes and the separator. The electrode according to the present invention is applicable to the polarized electrode of such an electric double layer capacitor.

The electrode according to Example 1 of the present invention will next be described with reference to the drawings.

### Example 1

In Example 1, activated carbon serving as the active material, acetylene black serving as the conducting auxiliary agent, and PVDF (polyvinylidene fluoride) serving as the fluorine containing binder were mixed to prepare a coating material (a solution to be applied to the electrode). Subsequently, the coating material was applied to a current collector formed of Al foil and was dried to produce electrode samples No. 1 to No. 4. The material for the current collector is not limited to Al foil, but, for example, metal foil other than Al foil, metal mesh, or perforated metal may be employed.

First, an electrode containing activated carbon (the activated carbon content X=90 wt. %) was produced as sample No. 1. In this case, the weight ratio of the conductive auxiliary agent to the binder was 1:3 (the same ratio was employed for samples No. 2 to No. 4). That is, in sample No. 1, the content of the conductive auxiliary agent was 2.5 wt. % (=10 wt. %×¼), and the content of the binder was 7.5 wt. % (=10 wt. %×¾).

The electrode of sample No. 1 was measured for the fluorine content A on the electrode surface by means of an XRF (X-ray fluorescence) analyzer. Further, adhesive tape was applied to the surface of the electrode. Subsequently, the applied adhesive tape was pulled in the perpendicular direction to the surface to force a part of the electrode to be stripped off. The stripped surface (the fracture surface) generated by the stripping was assumed to be the minimum strength surface inside the electrode, and this minimum strength surface was measured for the fluorine content B by means of an XRF analyzer. In addition, the fluorine ratio Y (=B/A) was calculated from the thus-obtained fluorine contents A and B.

Next, an electrode having an activated carbon content X of 92.5 wt. % was produced as sample No. 2. Also, an electrode having an activated carbon content X of 95 wt. % was produced as sample No. 3, and an electrode having an activated carbon content X of 97.5 wt. % was produced as sample No. 4. The same experiment as for sample No. 1 was repeated for these samples.

The experimental results are shown in Table 1.

TABLE 1

| | Activated | | | |
|---|---|---|---|---|
| | carbon | | Fluorine | Fluorine |
| Sample | content X | Fluorine | content A | content B |
| No. | (wt. %) | ratio Y | (kcps) | (kcps) |
| 1 | 90 | 0.25 | 1.58 | 0.4 |
| 2 | 92.5 | 0.35 | 1.61 | 0.56 |
| 3 | 95 | 0.44 | 1.6 | 0.7 |
| 4 | 97.5 | 0.6 | 1.61 | 0.97 |

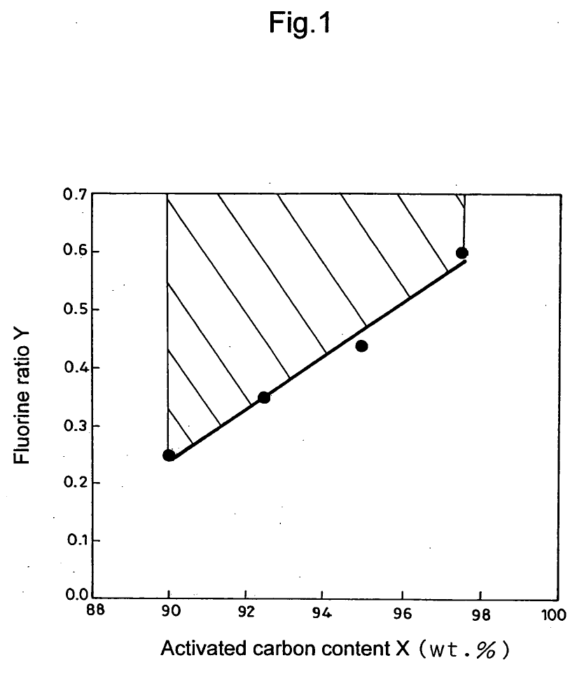

FIG. 1 is a graph based on the data shown in Table 1 and showing the relationship between the activated carbon content X and the fluorine ratio Y. In the diagonally shaded area in FIG. 1, an electrode can be produced which has the activated carbon content (the filling content of the active material) X and the fluorine ratio Y satisfying the relationship Y≧0.046 X−3.905. At the same time, this electrode has a filling content X of the active material of 90 wt. % or more and 97.5 wt. % or less. Thus, an electrode was obtained which had a filling density of the active material higher than that of a conventional electrode and had a high energy density.

Further, the present inventor studied the relationship between the specific surface area of the active material and electrostatic capacitance and the relationship between the specific surface area of the active material and the volumetric capacitance of the electrode.

The results are shown in Table 2.

TABLE 2

| Specific surface | Electrostatic | Volumetric capacitance |
|---|---|---|
| area (m²/g) | capacitance (F/g) | (F/cm³) |
| 800 | 22.0 | 12.0 |
| 1132 | 27.3 | 17.4 |
| 1241 | 28.0 | 18.0 |
| 1295 | 28.8 | 18.5 |
| 1400 | 29.0 | 17.7 |
| 1958 | 29.8 | 18.5 |
| 2500 | 27.8 | 18.6 |

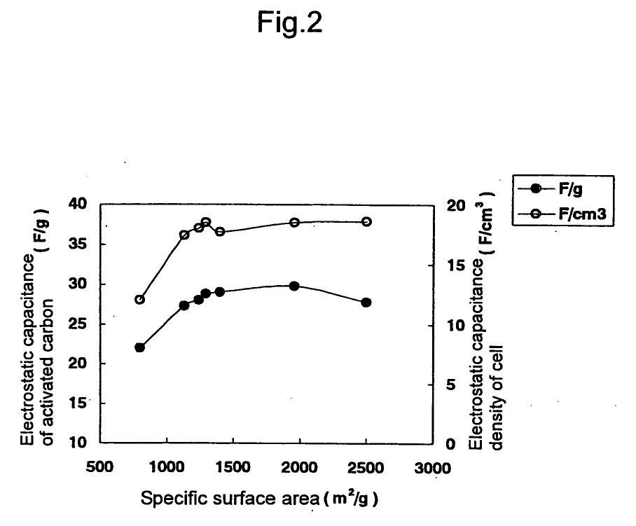

FIG. 2 is a graph based on the data shown in Table 2 and showing the relationship between the specific surface area of the active material and the electrostatic capacitance and the relationship between the specific surface area of the active material and the volumetric capacitance of the electrode. In this case, the values of the specific surface area of the active material were determined by means of the BET method.

As shown in FIG. 2, the electrostatic capacitance and the volumetric capacitance gradually decrease as the specific surface area of the active material decreases beyond 1000 m²/g. They reach the minimum values at the data collection point of a specific surface area of 800 m²/g. Hence, it is expected that the electrostatic capacitance and the volumetric capacitance further decrease as the specific surface area decreases beyond 800 m²/g, causing difficulty in producing an electrode having a high energy density. Therefore, the specific surface area of the active material is preferably 800 m²/g or more.

On the other hand, the electrostatic capacitance and the volumetric capacitance are almost steady when the specific surface area of the active material increases from approximately 1000 m²/g to larger values. They reach the maximum values at the data collection point of a specific surface area of 2500 m²/g. Hence, it is expected that the increased ratios of the electrostatic capacitance and the volumetric capacitance are not changed even when the specific surface area increases beyond 2500 m²/g. This may be because, as the specific surface area increases, the size of the fine pores formed on the surface of the active material decreases, and thus ions (salvation ions) which are contained in an electrolytic solution and involved in the electric capacitance cannot adhere to the fine pores. In this case, an increase in the specific surface area does not contribute to an increase in the electric capacitance. Further, if the specific surface area of the active material is larger than 2500 m²/g, the packing of the active material is deteriorated, so that the energy density does not sufficiently increase when an electrochemical device is produced. From the above reasons, the specific surface area of the active material is preferably 2500 m²/g or less.

Accordingly, if the specific surface area of the active material is adjusted within the range of 800 to 2500 m²/g, satisfactory values can be obtained for both the capacitance of the electrode material itself (the electrostatic capacitance) and the capacitance upon forming the electrode (the volumetric capacitance). Therefore, an electrode having a higher energy density can be obtained. Further, as is clear from FIG. 2, the specific surface area of the active material more preferably falls within the range of 1000 to 2000 m²/g.

The electrode according to the present invention is applicable to an electrochemical device typified by a battery, a capacitor, or the like. Moreover, the electrochemical device according to the present invention is suitable for, for example, a cellular phone and a personal computer.

What is claimed is:

1. An electrode comprising at least an active material, a conductive auxiliary agent, and a fluorine containing binder for binding the active material to the conductive auxiliary agent, wherein
a fluorine ratio Y and a filling content X of the active material in the electrode (90 wt. %≦X≦97.5 wt. %) satisfy a relationship of Y≧0.046 X−3.905, the fluorine ratio Y being a ratio of a fluorine content B on a minimum strength surface inside the electrode to a fluorine content A on the surface of the electrode (Y=B/A).

2. The electrode according to claim 1, wherein
the active material is composed of a carbon material having a specific surface area of 800 to 2500 m²/g as determined by means of a specific surface area measuring method.

3. An electrochemical device comprising the electrode according to claim 1.

4. An electrochemical device comprising the electrode according to claim 2.

5. An electric double layer capacitor comprising the electrode according to claim 1.

6. An electric double layer capacitor comprising the electrode according to claim 2.
